(19) United States
(12) Patent Application Publication
(10) Pub. No.: US 2003/0066798 A1
(43) Pub. Date: Apr. 10, 2003

(54) Producing carbon dioxide gas for horticultural use

(76) Inventor: Joseph T. Sanok III, Arcadia, CA (US)

Correspondence Address: CROWELL & MORING LLP, INTELLECTUAL PROPERTY GROUP, P.O. BOX 14300, WASHINGTON, DC, 20044-4300, US

(21) Appl. No.: 10/267,875

(22) Filed: Oct. 10, 2002

Related U.S. Application Data
(60) Provisional application No. 60/327,771, filed on Oct. 10, 2001.

(51) Int. Cl. B01D 21/28

(52) U.S. Cl. 210/542

(57) ABSTRACT

A machine that produces Carbon Dioxide Gas for horticultural use is described. The machine produces CO2 gas by accurately controlling a chemical reaction between an acid and a base. The chemicals involved are Sodium Bicarbonate (Baking Soda) and Muriatic Acid (Hydrochloric swimming pool acid). The machine comprises a plastic container, a peristaltic pump, a submersible mixing pump and an output filter. The peristaltic pump draws acid and pushes the acid into the plastic container through acid resistant tubing. The acid exits the tubing directly into the flow of water mixed with Sodium Bicarbonate created by a submersible mixing pump mounted inside the plastic container. The acid/base mixture combines to produce CO2 gas and salt water. The gas builds inside the plastic container and then exits via another tube. This tube terminates with an acid filter, which scrubs away any stray acid fumes allowing only clean CO2 gas to exit.

### CROSS REFERENCE TO RELATED APPLICATIONS

This application claims the priority of provisional application serial No. 60/327,771 filed Oct. 10, 2001.

### BACKGROUND AND SUMMARY OF THE INVENTION

Carbon dioxide Enrichment will dramatically increase the growth of green plants. Green plants use carbon dioxide (CO2) and water in the presence of light to synthesize organic compounds. The plant then converts these organic compounds into elements that it can use (food). This process is called photosynthesis. The most common methods of supplying carbon dioxide gas for greenhouse use are by compressed gas cylinders or combustion. Each of these methods has its advantages and drawbacks. Compressed gas cylinders, although simple to use, are heavy and need to be exchanged frequently. Compressed gas cylinders require professional refilling and therefore require transportation to and from a refill facility. The combustion method burns natural gas or propane gas to create CO2. While it's inexpensive to operate, it is best suited for very large areas due to the high amount of undesirable heat created in the process. The combustion method also presents a hazard by generating a flame inside an area usually in close proximity to plant foliage.

The CO2 Machine according to the invention offers an alternative to the above-mentioned methods by presenting users the convenience of producing CO2 gas by chemical reaction without having to exchange heavy cylinders and without generating heat inside the grow area. The CO2 machine uses chemicals that are inexpensive and widely available.

Other objects, advantages and novel features of the present invention will become apparent from the following detailed description of the invention when considered in conjunction with the accompanying drawings.

### BRIEF DESCRIPTION OF THE DRAWINGS

FIG. 1 is a front view of one embodiment of the CO2 machine according to the present invention with sodium bicarbonate and muriatic acid bottle in view;

FIG. 2 is a side view of one embodiment of the CO2 machine showing the peristaltic pump, tubing and drain valve;

FIG. 3 is a view of the acid pick-up line cap being installed onto the acid bottle;

FIG. 4 is a front view of one embodiment of the CO2 machine with the screw lid off and water added;

FIG. 5 is a view of one embodiment of the CO2 machine with the screw lid off and Sodium Bicarbonate added;

FIG. 6 is a view of one embodiment of the CO2 machine with the screw lid being installed;

FIG. 7 is a side view of one embodiment of the CO2 machine showing the peristaltic pump and electronics control box;

FIG. 8 is a cross section drawing of the Beckett Co. pump showing the seal cap and grease reservoir modification;

FIG. 9 is a cross section drawing of the acid bottle cap concept showing acid line tubing and vent line tubing;

FIG. 10 is a view of one embodiment of the acid fume filter terminating the CO2 gas output line;

FIG. 11 is a view of the mixing pump, acid line, pump output tube and electrical cord inside the plastic container;

FIG. 12 is a conceptual drawing of pumping acid by the use of venturi suction method from a submersible mixing pump;

FIG. 13 is a cross section drawing of regulating the flow of acid when using the venturi method of acid injection;

FIG. 14 is a schematic drawing of the peristaltic pump motor drive electronics circuit;

FIG. 15 is a drawing of a method to regulate the flow of acid by use of a drip chamber and clamp; and

FIG. 16 is cross section drawing of the magnetic drive, ceramic bushing mixing pump modification.

### DETAILED DESCRIPTION OF THE DRAWINGS

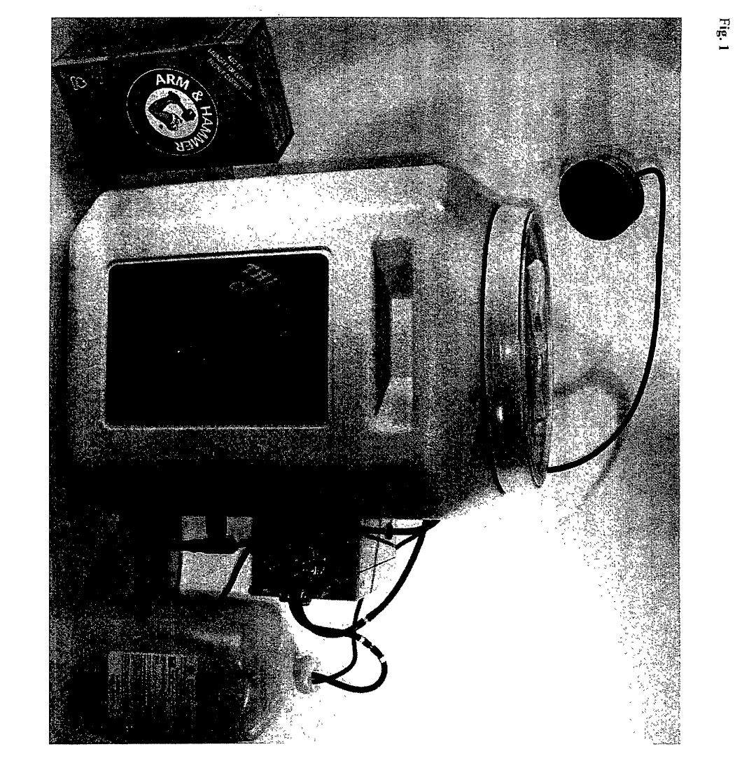

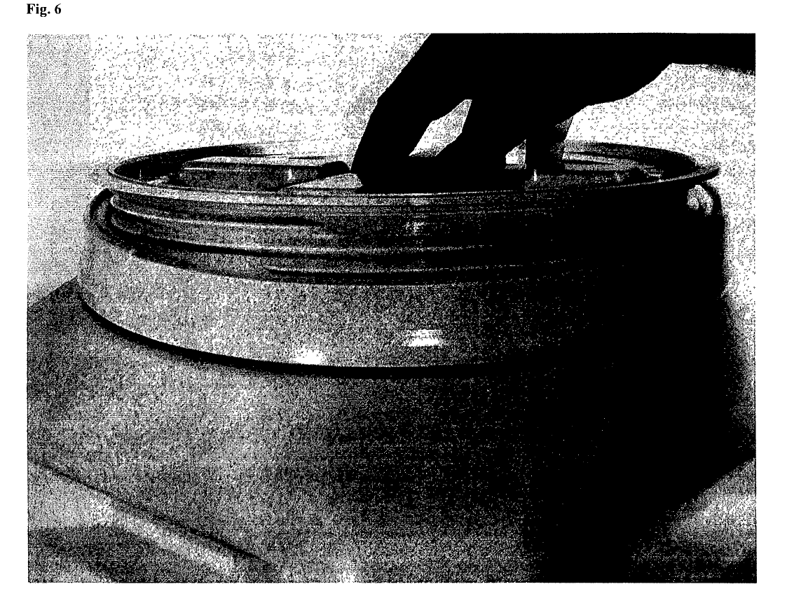

Referring to FIG. 1 the view shows the plastic container where the two chemicals are mixed to produce CO2 gas. The plastic container is made of a high-density polyethylene material. The container may be made out of any material that resists strong acid and base chemicals. The plastic container incorporates a FIG. 6 large diameter threaded lid with an o-ring seal.

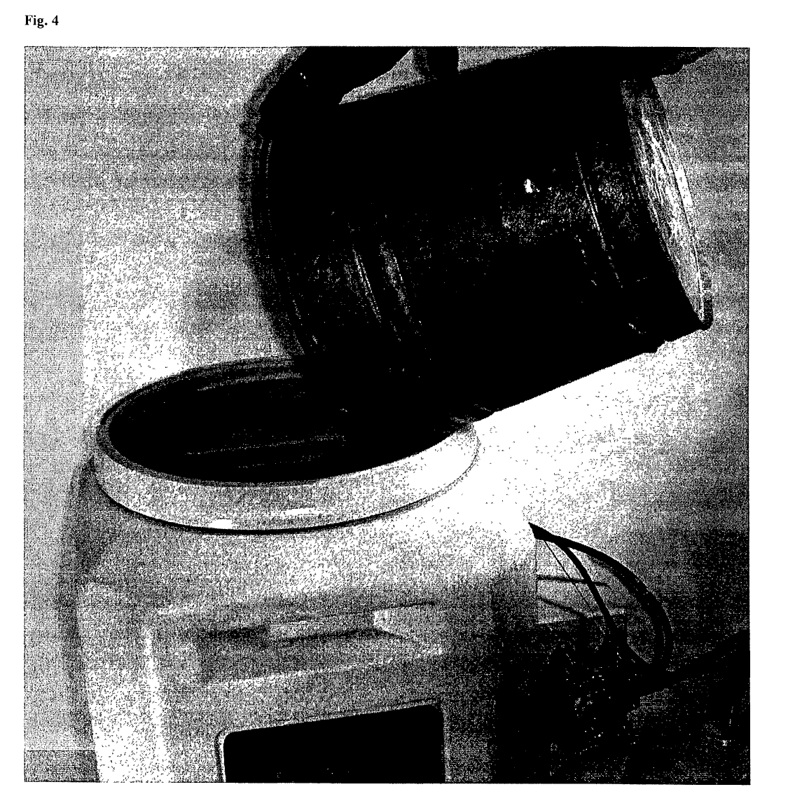

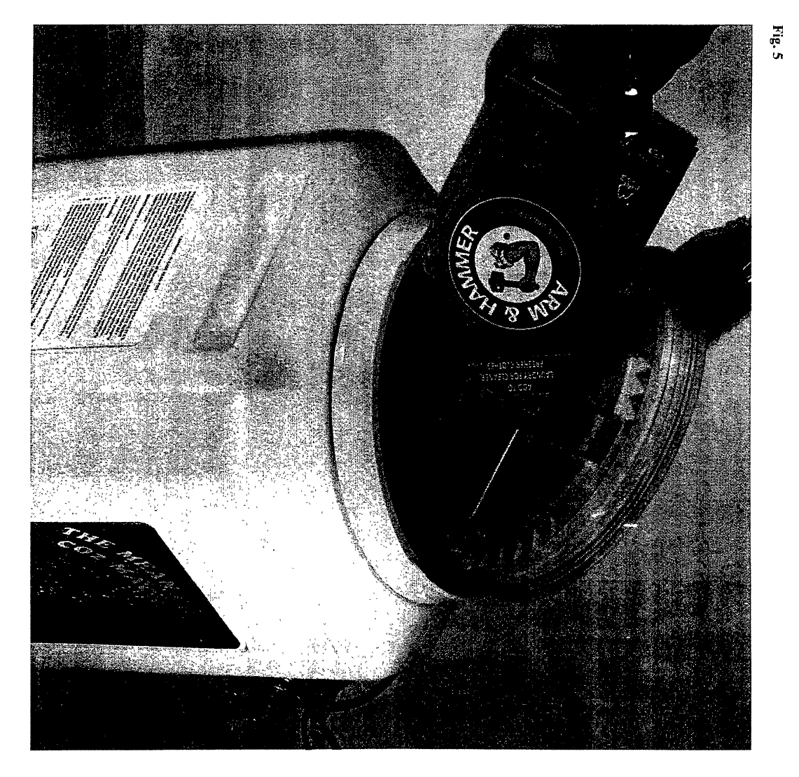

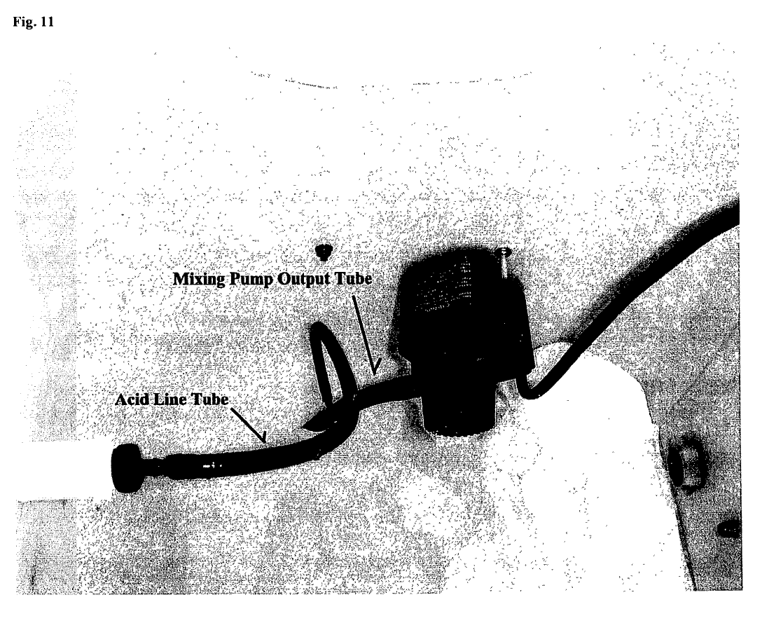

Referring to FIG. 4 water is added to the container. The exact amount is not critical, however, it must completely submerge the submersible mixing pump FIG. 11 after the FIG. 5 Sodium Bicarbonate has been added.

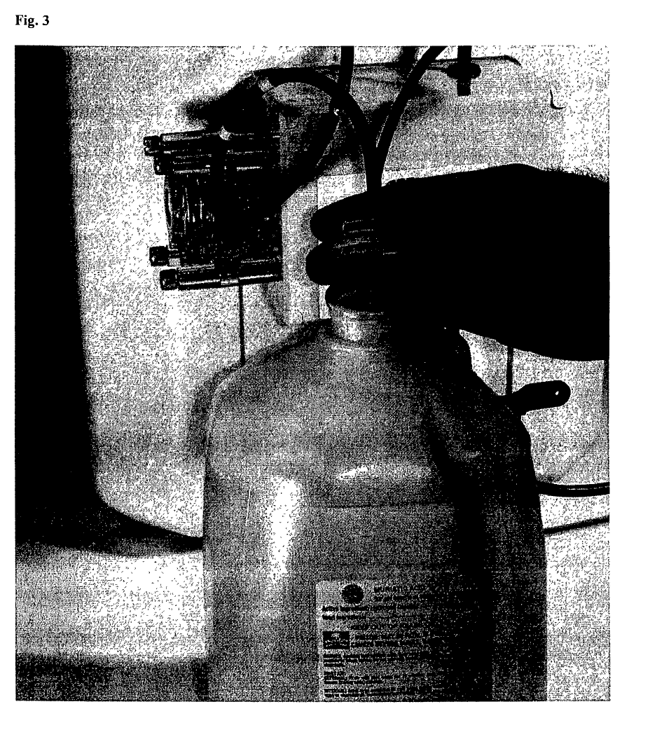

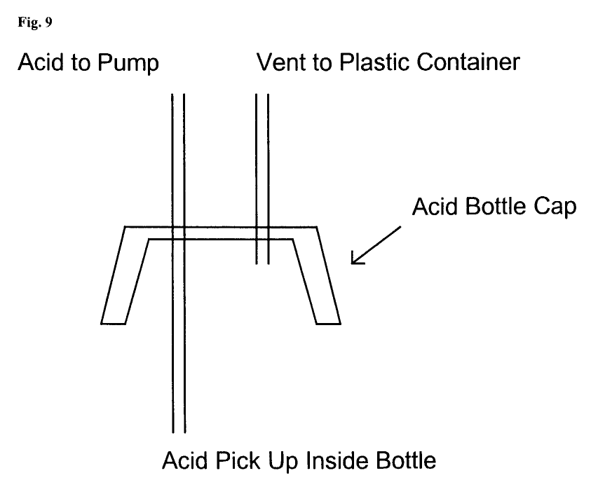

Referring to FIG. 3 & FIG. 9 a specialized cap made to fit standard 1 gallon acid bottles contains the pick up line tubing and vent tubing that will return to the reaction chamber.

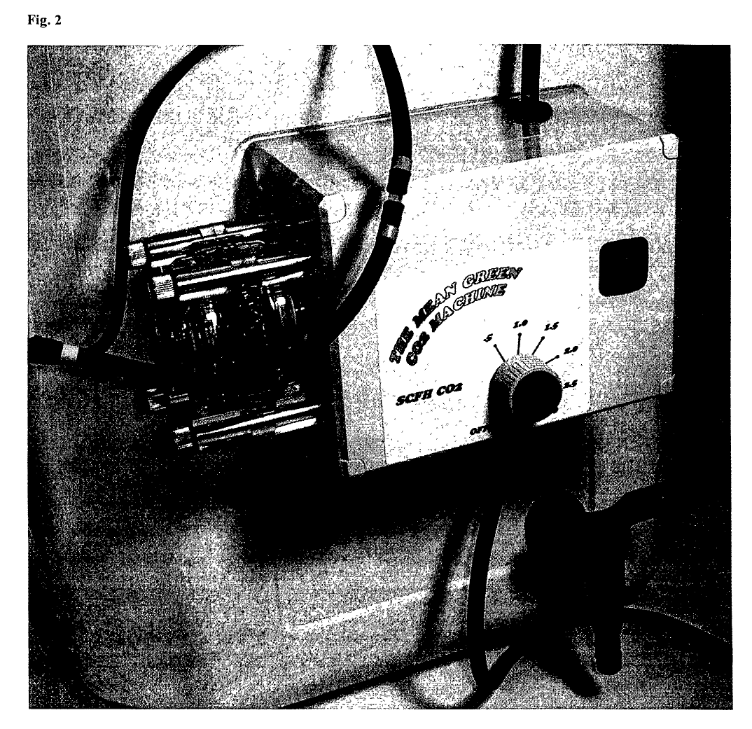

Referring to FIG. 2 a peristaltic pump draws acid from the bottle that it is packaged in by a special FIG. 3 cap fitted with a vent tube. The vent tube terminates inside the plastic container. It is important that this vent tube terminate inside the plastic container above the water level so as to preclude the escape of acid fumes into the air. The advantage of using a peristaltic pump is that it will pump the acid without its mechanical parts contacting the corrosive liquid. Any pump that is compatible with a strong acid may be used.

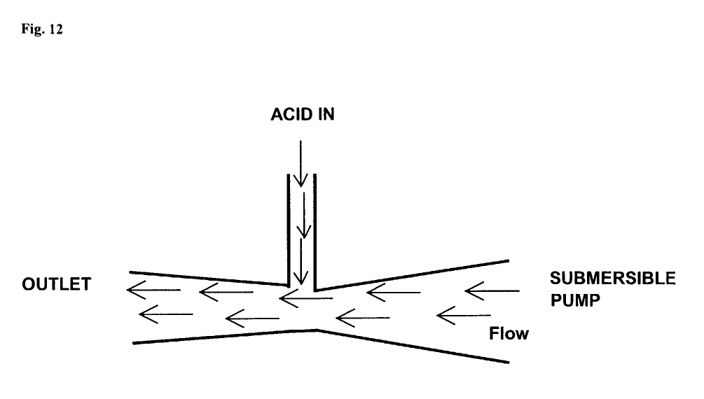

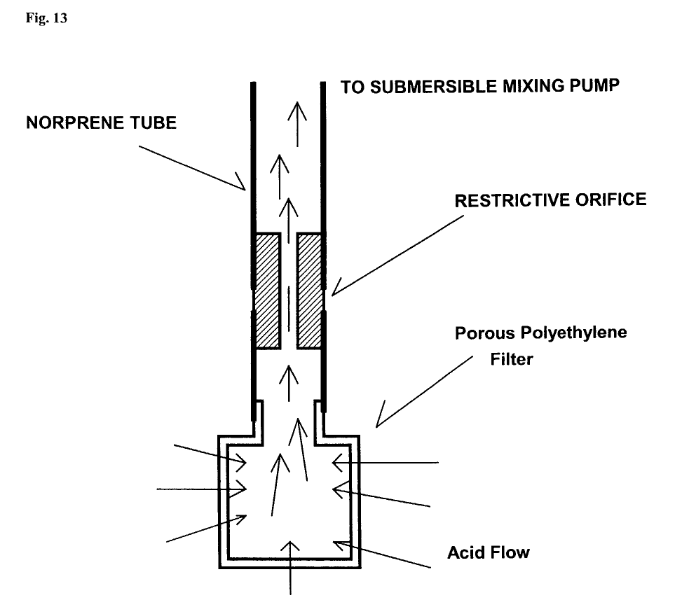

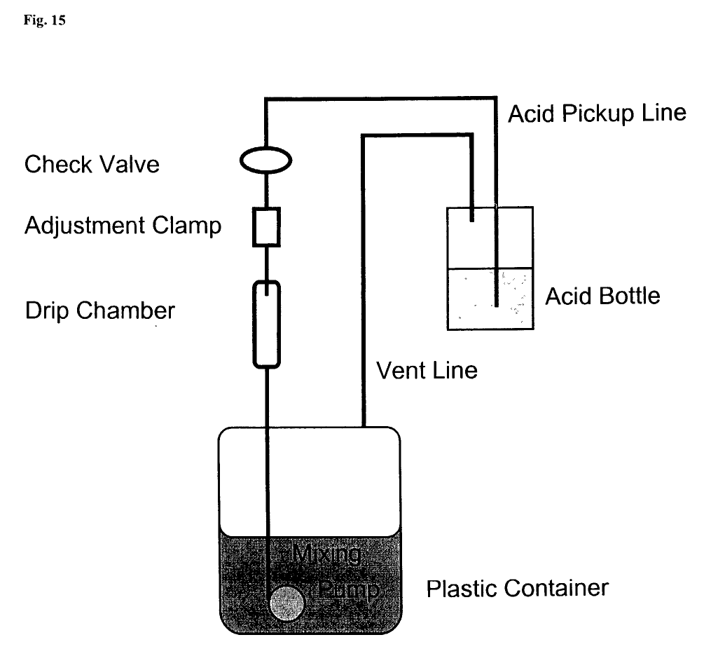

A variation would make use of the Venturi suction effect of FIG. 12. A pressure difference between the inlet and outlet creates a vacuum inside the flow tube, which initiates suction from a side port connected to an acid bottle. One possible design variation could make use of Venturi suction created by the mixing pump inside the reaction chamber. Suction created could draw acid directly from its container without the need for a separate Peristaltic pump. The flow rate would be controlled by the use of various sized orifices FIG. 13 coupled inline with the acid resistant tubing or by a FIG. 15 drip chamber and adjustable clamp. A FIG. 13 filter made of porous polyethylene would prevent the small orifice from becoming clogged with any debris present in the acid. This method would greatly reduce manufacturing costs, although, it would trade off precision control over CO2 gas flow rates. This method would best suit users with CO2 controllers and not those operating in a manual mode.

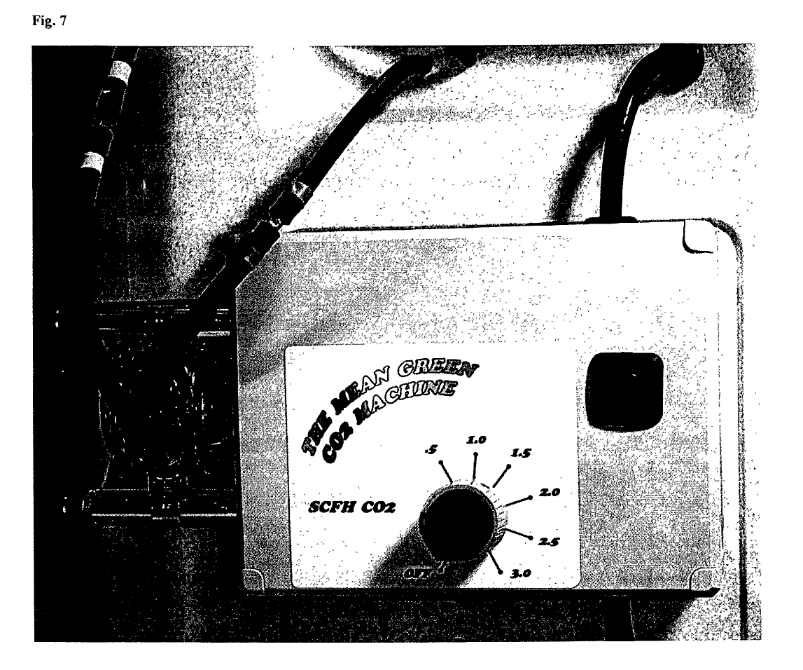

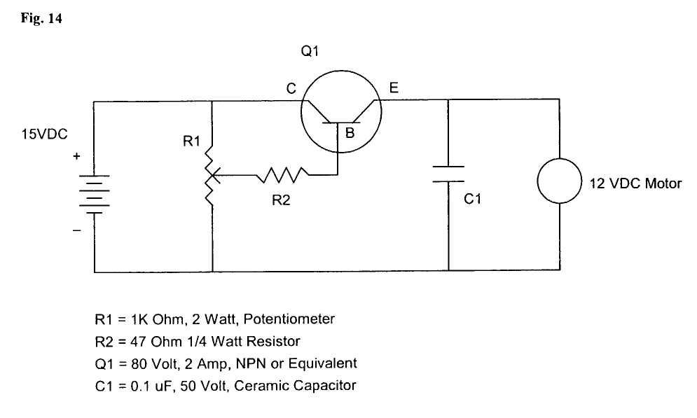

Referring to FIG. 14 a 12 VDC motor drives the peristaltic pump. Peristaltic pump speed is adjusted and maintained by the drive electronics. The drive electronics circuit FIG. 14 consists of a regulated 12 volt DC power supply, an NPN power transistor and a 1 K ohm switch potentiometer. The user may adjust the amount of CO2 gas output flow by adjusting the acid flow rate into the plastic container. A label FIG. 7 surrounding the potentiometer adjustment knob is graduated in increments of 0.5 standard cubic feet per hour of CO2 gas flow. The metering accuracy assumes that 1 mole of sodium bicarbonate (NAHCO3) reacts with 1 mole of hydrochloric acid (HCI) to produce 1 mole of CO2 gas (22 cubic liters at standard temperature and pressure). The machine can run in manual mode, as a stand-alone unit or operate from any commercial CO2 controller. CO2 controllers measure the quantity of CO2 in the air expressed as Parts Per Million (PPM). The controller will turn the machine on or off per a preset level expressed as PPM. An 115 VAC input from any C02 controller will operate the CO2 machine the same as bottled C02 gas cylinders or combustion sources.

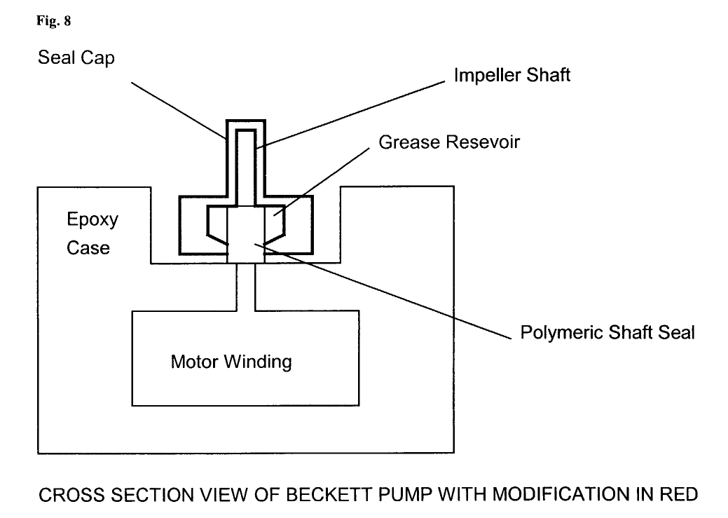

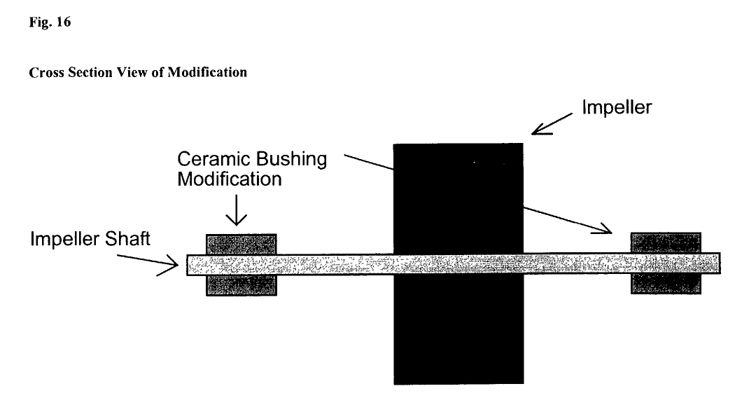

Referring to FIG. 11 a submersible mixing pump mounted inside the plastic container maintains a constant flow of water mixed with sodium bicarbonate. This is action is imperative as without constant mixing a salt barrier may form between the acid and base resulting in an eventual mass combinement and subsequent explosion. The output of the acid line is positioned at the end of the submersible pump output flow tube FIG. 11. The submersible pump is a 210-gallon per hour direct drive unit manufactured by the Beckett Company. The pump is fitted with a FIG. 8 modification enabling it to operate in a corrosive environment. The modification is a FIG. 8 cap seal manufactured of nylon, filled with grease and pressed over the output shaft of the submersible pump. This cap seal prevents liquid from reaching the main polymer seal. Another variation would be to use a magnetic drive pump manufactured by Rio Inc. Magnetic drive pumps do not require seals as there is no mechanical link between the drive motor and the impeller. Magnetic drive pumps do however expose impeller shaft bearings to the liquid environment. In addition to being somewhat corrosive, sodium bicarbonate is also gritty. Grit flowing inside a rotary bearing will cause premature wear and pump failure. A modification FIG. 16 to the magnetic drive pump would replace the rotating shaft bushing material with a ceramic bushing. Ceramic bushings offer very hard surfaces and thus will greatly extend the useable service life of the pump. Any pump that can withstand a corrosive and gritty environment may be used.

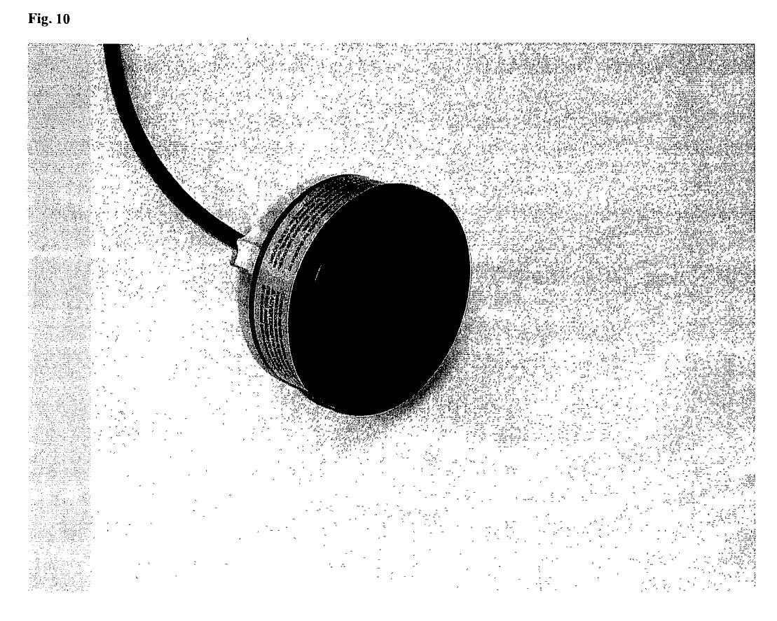

Referring to FIG. 10, as Co2 gas exits the plastic container it travels through a tube terminated with an acid fume filter. The filter is a standard respirator filter made by the North Co. for use on personal protection respirator masks. The filter will scrub any acid fumes that managed to escape the plastic container.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A C02 producing machine, comprising:
a reaction chamber container resistant to strong acid and base chemicals;
a mixing pump arranged so as to be submersible within the container,
an acid container that stores acid,
a second pump operable to draw acid from the acid container into the reaction chamber, whereby the mixing pump facilitates a reaction with a base in the reaction chamber to produce C02; and
a gas output arranged in the container for outputting the C02 produced therein.

2. The C02 machine according to claim 1, wherein the second pump is a peristaltic pump that draws acid from the acid container.

3. The C02 machine according to claim 1, wherein the second pump is a venturi suction-type pump in which a pressure difference between an inlet and an outlet creates a vacuum inside a flow tube for suctioning acid from the acid container.

4. The CO2 machine according to claim 3, wherein the venturi suction-type pump utilizes the mixing pump inside the container to create the venturi-suction in the flow tube.

5. The CO2 producing machine according to claim 1, wherein the reaction chamber container is made of a high-density polyethylene material.

6. The CO2 producing machine according to claim 1, wherein the gas output includes an acid fume filter.

7. The CO2 producing machine according to claim 1, further comprising:
a vent tube operably arranged between the reaction chamber and the acid container.
